(19) United States
(12) Patent Application Publication
(10) Pub. No.: US 2025/0291230 A1
(43) Pub. Date: Sep. 18, 2025

(54) Optical tensor core, Method, and Applications

(71) Applicant: Xuan Sun, Rochester, NY (US)

(72) Inventor: Xuan Sun, Rochester, NY (US)

(21) Appl. No.: 18/605,979

(22) Filed: Mar. 15, 2024

(51) Int. Cl. G02F 1/383; G02F 1/365

(52) U.S. Cl. CPC G02F 1/383; G02F 1/365; G02F 2203/56

(57) ABSTRACT

An optical tensor core includes a device platform, a broadband, phase-locked, optical frequency comb generator, an array of electro-optic (EO) modulators, wherein a vector, {Xⱼ} and a matrix, {Aᵢⱼ} are encoded onto optical comb mode fields, and a non-linear waveguide, wherein a sum frequency generation (SFG) operation occurs directly on the optical comb mode fields so as to realize a multiply-accumulate (MAC) operation between the vector {Xⱼ} and the matrix {Aᵢⱼ}. An integrated system and related methodologies and applications are disclosed.

### RELATED APPLICATION DATA

The instant application claims priority to U.S. provisional Application No. 63/458,190 filed 10 Apr. 2023, the subject matter of which is hereby incorporated by reference in its entirety to the fullest extent allowed by law.

### GOVERNMENT FUNDING

N/A.

### BACKGROUND

Aspects and embodiments most broadly are in the field of photonics enabled mathematics, more particularly optical tensor cores, associated methods of use, and applications thereof, and most particularly to a hyperspectral optical tensor core for low-power, ultrafast, parallel computation of matrix operations based upon a novel multiply-accumulate (MAC) operation principle. Matrix-vector multiplication (MVM) is a fundamental mathematical operation used extensively for information processing in science, engineering, and artificial intelligence. Conventionally, MVM is primarily performed by electronic microprocessors based upon complementary-metal-oxide-semiconductor (CMOS) technology. Explosive growth of data and information in the past decade, such as that in internet traffic and artificial intelligence algorithms has imposed extraordinary demands on the capacity and performance of CMOS microprocessors. Unfortunately, the ultimate performance growth of CMOS microprocessors is limited due to the faltering of Moore's law.

In recent years, photonics has appeared as a promising approach for accelerating matrix computation, showing great potential for low power consumption, small computing latency, and significant computing parallelism. To date, photonic MVM accelerators are primarily based upon the following four approaches: Mach-Zehnder interferometer (MZI) array/matrix, micro-resonator (MR) array/matrix, cross-waveguide (XWG) array/matrix, and free-space diffractive multiple-plane light conversion (MPLC). The MZI and free-space MPLC approaches both lack direct one-to-one mapping between the matrix elements and the controlling phase elements. As a result, their programming requires sophisticated backward-propagation training that limits their applications for real-time MVM. The MR approach based on thermo-optic tuning and the XWG approach based on phase-change material both suffer from serious propagation losses and/or device stability that limits the computing precision and requires significant power consumption. Moreover, the MZI, MR, and XWG approaches all exhibit limited scalability since this relies on the number of spatially sequential components that inevitably encounter severe accumulation of propagation loss. Finally, the MPLC, MR, and XWG approaches all exhibit poor programming speed and thus limited computing speed due to the slow speed of spatial light modulation, thermo-optic tuning, and optical heating for changing material properties.

Recognizing these shortcomings, we herein describe device and method solutions enabled by the aspects and embodiments set forth below and as claimed.

### SUMMARY

An aspect of the invention is an optical tensor core. In a non-limiting embodiment, the optical tensor core includes a device platform, a broadband, phase-locked, optical frequency comb generator, a plurality of electro-optic (EO) modulators adapted to EO modulate a respective plurality of comb mode fields of a broadband, phase-locked, optical comb produced by the comb generator, wherein a vector, {Xⱼ}, and a matrix, {Aᵢⱼ} are encoded onto the optical comb mode fields, and a non-linear waveguide operationally integrated with an output port of the EO modulators, wherein a sum frequency generation (SFG) operation occurs directly on the optical comb mode fields so as to realize a multiply-accumulate (MAC) operation between the vector, {Xⱼ}, and the matrix, {Aᵢⱼ}, further wherein at least one of the frequency comb generator, the plurality of electro-optic (EO) modulators, and the non-linear waveguide are disposed on the non-linear photonics platform. In various alternative exemplary, non-limiting embodiments the optical tensor core may further include one or more of the following elements, components, or limitations alone or in various combinations as a PHOSITA would recognize:
wherein the broadband, phase-locked, optical frequency comb generator is a high-Q microresonator;
further comprising a wavelength division demultiplexer (WDM DEMUX) and a wavelength division multiplexer (WDM MUX) operationally disposed between the optical frequency comb generator and the non-linear waveguide;
   wherein the frequency comb generator, the EO modulator array, the nonlinear optical waveguide, and the WDM MUX and WDM DEMUX are disposed on separate, operationally integrated device platforms;
wherein the device platform is one of a lithium niobate (LiNBO₃), lithium tantalate (LiTaO₃), potassium niobate (KNbO₃), III-V semiconductors (AlN, GaN, GaP, GaAs, AlGaAs, InP), barium titanate (BaTiO₃), silicon nitride, silica, tantalum pentoxide (Ta₂O₅), or a composite medium formed by integrating one of these materials with a dielectric material such as silicon nitride or silicon dioxide.

An aspect of the invention is an optical tensor core system. In an exemplary, non-limiting embodiment the optical tensor core system includes a photonic computing engine comprising an optical tensor core, a pump laser suitably adapted to produce a broadband, phase-locked, optical frequency comb, and an optical receiver array suitably adapted to detect a computed optical output from the optical tensor core, and an electrical I/O circuit suitably adapted to provide programming voltages to the optical tensor core and to process the received signals from the optical receiver array, and to characterize the computing performance. In various alternative exemplary, non-limiting embodiments the optical tensor core may further include one or more of the following elements, components, or limitations alone or in various combinations as a PHOSITA would recognize:
wherein the optical tensor core includes a device platform, a broadband, phase-locked, optical frequency comb generator, a plurality of electro-optic (EO) modulators adapted to EO modulate a respective plurality of comb mode fields of a broadband, phase-locked, optical comb produced by the comb generator, wherein a vector, {Xⱼ}, and a matrix, {Aᵢⱼ} are encoded onto the optical comb mode fields, and a non-linear waveguide operationally integrated with an output port of the EO modulators, wherein a sum frequency generation (SFG) operation occurs directly on the optical comb mode fields so as to realize a multiply-accumulate (MAC) operation between the vector, {Xⱼ}, and the matrix, {Aᵢⱼ};
wherein the broadband, phase-locked, optical frequency comb generator is a high-Q microresonator;
further comprising a wavelength division demultiplexer (WDM DEMUX) and a wavelength division multiplexer (WDM MUX) operationally disposed between the optical frequency comb generator and the non-linear waveguide;
   wherein the frequency comb generator, the EO modulator array, the nonlinear optical waveguide, and the WDM MUX and WDM DEMUX are disposed on separate, operationally integrated device platforms;
wherein the device platform is one of a lithium niobate (LiNBO₃), lithium tantalate (LiTaO₃), potassium niobate (KNbO₃), III-V semiconductors (AlN, GaN, GaP, GaAs, AlGaAs, InP), barium titanate (BaTiO₃), silicon nitride, silica, tantalum pentoxide (Ta₂O₅), or a composite medium formed by integrating one of these materials with a dielectric material such as silicon nitride or silicon dioxide.

An aspect of the invention is a method for performing a multiply-accumulate (MAC) operation between a vector element, {Xⱼ}, and a matrix element, {Aᵢⱼ} using an optical tensor core. In an exemplary, non-limiting embodiment the method includes the steps of generating a broadband, phase-locked optical comb having a spectral bandwidth, encoding a computing vector, {Xⱼ}, and a matrix, {Aᵢⱼ} on different spectral bands of the optical comb mode field, and performing a sum frequency generation (SFG) operation directly on the vector-and matrix-encoded optical comb mode fields so as to realize a multiply-accumulate (MAC) operation between the vector, {Xⱼ}, and the matrix, {Aᵢⱼ}. In various alternative exemplary, non-limiting embodiments the method may further include one or more of the following steps, elements, components, or limitations alone or in various combinations as a PHOSITA would recognize:
wherein the step of generating the broadband, phase-locked optical comb mode field further comprises one of four-wave mixing, parametric down-conversion, and electro-optic modulation;
wherein the step of encoding a computing vector with a length of N, {Xⱼ} (j=1, . . . , N), on the spectral bands of the optical comb mode field further comprises selecting a band of N comb modes at an equally spaced frequency set of {ωⱼ^{s}} (j=1, . . . , N) and electro-optically modulating the amplitude and phase of the selected band of comb modes to generate the computing vector, {Xⱼ};
wherein the step of encoding a matrix {Aᵢⱼ} with a dimension of M×N on the spectral bands of the optical comb mode field further comprises one of: i) (a) encoding a row of the matrix {Aᵢⱼ} (j=1, . . . , N) with a length of N onto a band of N comb modes at an equally spaced optical frequency set of {ωⱼ^{l}} (j=1, . . . , N), (b) encoding different rows of the matrix {Aᵢⱼ} onto different spectral bands of the comb; and ii) (a) selecting a band of N comb modes at an equally spaced frequency set of {ωⱼ^{l}} (j=1, . . . , N), (b) splitting the whole comb band equally into M parts, and (c) using each part to encode a row of {Aᵢⱼ};
wherein the step of encoding vector and matrix further comprises biasing the EO modulators with appropriate voltages so as to compensate for a spectral non-uniformity of the input comb.
wherein the step of encoding vector/matrix and the step of MAC operation further comprise encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency ω^{c}=ωⱼ^{s}+ωⱼ^{l} (j=1, . . . , N), with an amplitude of Yᵢ=ΣⱼηAᵢⱼXⱼ (where η is a slope efficiency of the SFG process), wherein the MAC operation realizes a dot product between the two vectors;
wherein, in conjunction with a matrix encoding method comprising (a) encoding a row of the matrix {Aᵢⱼ} (j=1, . . . , N) with a length of N onto a band of N comb modes at an equally spaced optical frequency set of {ωⱼ^{l}} (j=1, . . . , N), and (b) encoding different rows of the matrix {Aᵢⱼ} onto different spectral bands of the comb, and a dot product operation comprising encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency ω^{c}=ωⱼ^{s}+ωⱼ^{l} (j=1, . . . , N), with an amplitude of Yᵢ=ΣⱼηAᵢⱼXⱼ (where η is a slope efficiency of the SFG process), the step of MAC operation further comprises SFG between the comb band carrying the vector {Xⱼ} and different comb bands carrying different rows of the matrix {Aᵢⱼ} to produce a set of converted optical fields at equally spaced frequencies ωᵢ^{c} (i=1, . . . , M), each with an amplitude of Yᵢ=ΣⱼηAᵢⱼXⱼ (i=1, . . . , M), wherein the MAC operation realizes a matrix-vector multiplication;
wherein, in conjunction with a matrix encoding method comprising (a) selecting a band of N comb modes at an equally spaced frequency set of {ωⱼ^{l}} (j=1, . . . , N), (b) splitting the whole comb band equally into M parts, and (c) using each part to encode a row of {Aᵢⱼ}, and a dot product operation comprising encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency w^{c}=wⱼ^{s}+wⱼ^{l} (j=1, . . . , N), with an amplitude of Yᵢ=ΣⱼηAᵢⱼXⱼ (where η is a slope efficiency of the SFG process), the step of MAC operation further comprises SFG in M separate nonlinear waveguides to realize dot product operations between the vector {Xⱼ} and individual rows of the matrix {Aᵢⱼ}, each in one nonlinear waveguide, to produce up-converted optical fields at a same frequency ω^{c}=ωⱼ^{s}+ωⱼ^{l} but with different amplitudes of Yᵢ=ΣⱼηAᵢⱼXⱼ (i=1, . . . , M), output from the set of nonlinear waveguides, wherein the MAC operation realizes a matrix-vector multiplication;
wherein the step of vector/matrix encoding and the step of MAC operation further comprises encoding the vector {Xⱼ} with appropriate order on a comb band at an equally spaced frequency set {ωⱼ^{s}} and encoding another vector {Wⱼ} with appropriate order on another comb band at an equally spaced frequency set {wⱼ^{l}}, and performing SFG between the two comb bands to produce optical fields at equally spaced frequencies of ω^{c}+mΩ (m=−N, . . . , +N) with amplitudes of Yₘ=ΣⱼηWⱼX_{(N-j+m)}, respectively, where Ω is the mode spacing of the combs, wherein the MAC operation realizes a convolution between {Xⱼ} and {Wⱼ}.

### BRIEF DESCRIPTION OF THE DRAWINGS

FIG. 1 is a schematic drawing conceptually illustrating related device and method elements, according to a non-limiting, exemplary embodiment.

FIG. 2 is a schematic drawing conceptually illustrating a layout of device elements and related functionalities, according to a non-limiting, exemplary embodiment.

FIG. 3 is a schematic drawing showing the layout of a hyperspectral optical tensor core device based upon a lithium niobate photonic integrated circuit platform that supports all required functionalities, according to a non-limiting, exemplary embodiment.

FIG. 4 is a schematic drawing showing a comb generation mechanism inside a high-Q microresonator via a) four-wave mixing, b) parametric down conversion, and c) electro-optic modulation, according to a non-limiting, exemplary embodiment.

FIG. 5 is a schematic drawing illustrating encoding a computing vector {Xⱼ} onto comb modes via electro-optic modulation (EOM), according to a non-limiting, exemplary embodiment.

FIG. 6(a) and (b) schematically illustrate two approaches for encoding a computing matrix {Aᵢⱼ} onto comb modes, according to a non-limiting, exemplary embodiment.

FIG. 7 is a schematic drawing illustrating sum frequency generation (SFG) performing an inner product operation, according to a non-limiting, exemplary embodiment.

FIG. 8(a) and (b), respectively, illustrate two approaches performing matrix-vector multiplication, corresponding to the matrix encoding schemes in FIGS. 6(a) and (b), according to a non-limiting, exemplary embodiment.

FIG. 9 schematically illustrates a SFG process performing a convolution operation, wherein the frequency ordering of {Wⱼ} is opposite to that of {Aᵢⱼ} in FIG. 7 for dot product, according to a non-limiting, exemplary embodiment.

FIG. 10(a) and (b), respectively, illustrate two approaches for realizing the optical tensor core, according to a non-limiting, exemplary embodiment.

FIG. 11 is a schematic drawing illustrating an integrated optical tensor core system, according to a non-limiting, exemplary embodiment.

### DETAILED DESCRIPTION OF NON-LIMITING, EXEMPLARY EMBODIMENTS

Disclosed embodiments are described with reference to the attached figures, wherein like reference numerals are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships and methods are set forth to provide a more complete understanding of the embodiments disclosed herein.

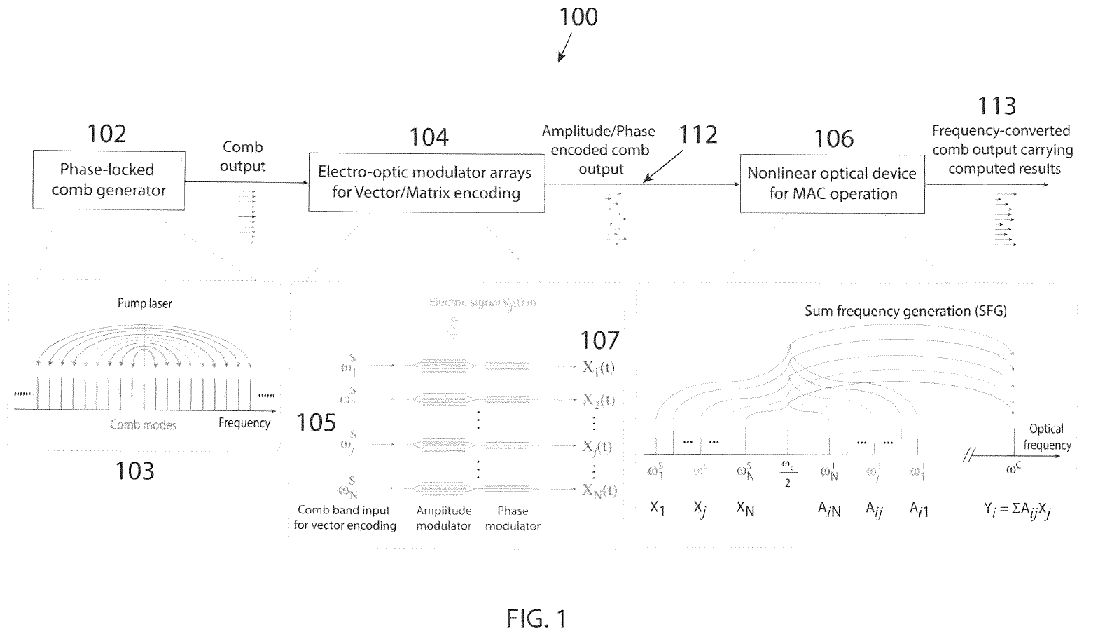

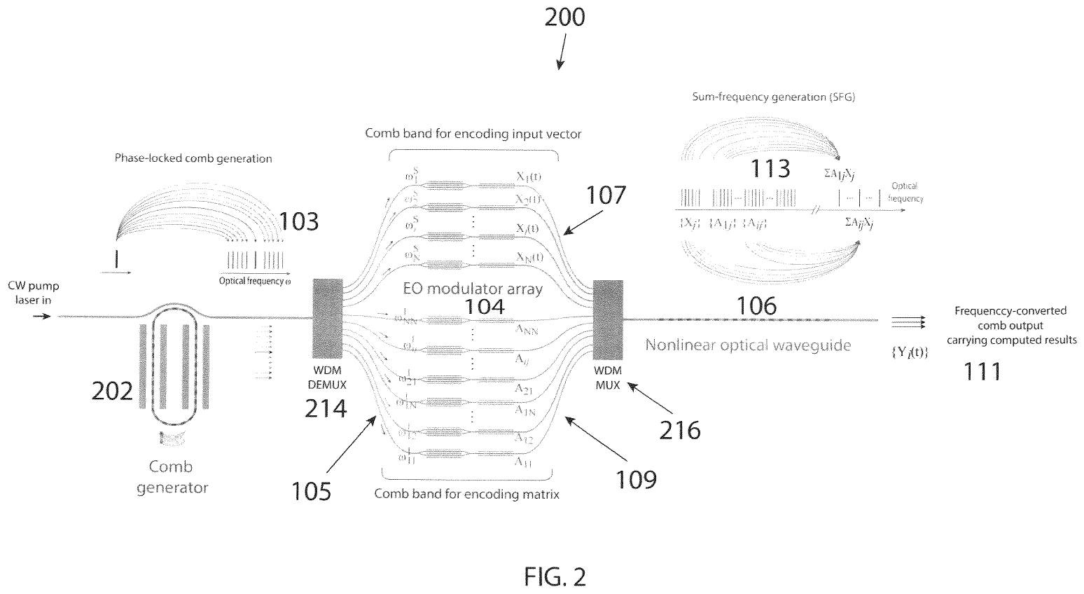

Described herein below is a hyperspectral optical tensor core for low-power, ultrafast, parallel computation of matrix operations, based upon a novel multiply-accumulate (MAC) operation principle, 100, the basic conceptual elements of which are illustrated in FIG. 1. Most generally, the optical tensor core 100 includes a broadband, phase-locked, optical frequency comb generator 102 to generate optical comb 103, an electro-optic (EO) modulator array 104 adapted to EO modulate a respective plurality of comb mode fields 105 of the optical comb, wherein a vector {Xⱼ} 107 and a computing matrix {Aᵢⱼ} 109 (FIG. 2) are encoded onto the optical comb mode fields, and a non-linear waveguide 106 operationally integrated with an output port 112 of the EO modulator array, wherein a sum frequency generation (SFG) operation 111 occurs directly on the optical comb mode fields so as to realize a multiply-accumulate (MAC) operation 113 between the vector, {Xⱼ}, and the matrix, {Aᵢⱼ}.

FIG. 2 is a schematic drawing further illustrating a layout 200 of device elements and related functionalities, following that of FIG. 1. A broadband phase-locked optical microcomb 103 is generated by a high-Q microresonator 202. The computing vector 107 and matrix 109 are both encoded on different spectral bands of the comb teeth via electro-optic modulators (EOMs) 104. MAC operation between the vector and the matrix is realized via sum-frequency generation (SFG) 113 inside a nonlinear waveguide 106. A wavelength-division demultiplexer (WDM DEMUX) 214 is employed to separate the microcomb into individual comb modes 105 for encoding the vector/matrix elements 107, 109. Similarly, a WDM MUX 216 is employed to combine the comb modes into the nonlinear waveguide 106 for SFG.

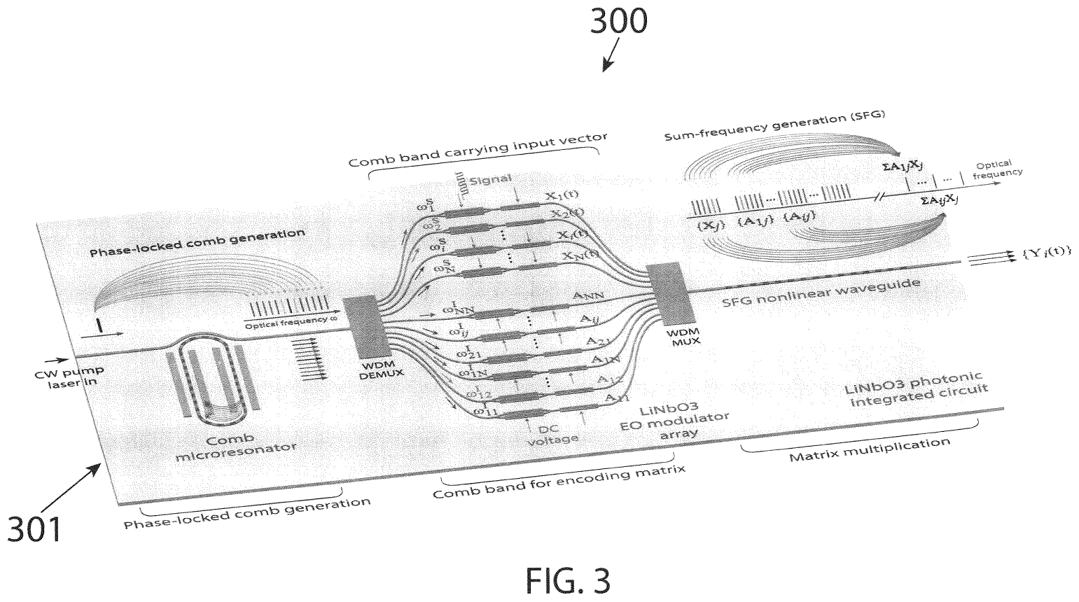

FIG. 3 schematically illustrates an optical tensor core device 300 fabricated on a thin-film lithium niobate (LN; LiNbO₃) photonic integrated circuit (PIC) device platform 301, which will support all the underlying functionalities of the device. As will be appreciated, other nonlinear photonics platforms such as lithium tantalate (LiTaO₃), potassium niobate (KNbO₃), III-V semiconductors (AlN, GaN, GaP, GaAs, AlGaAs, InP), barium titanate (BaTiO₃), silicon nitride, silica, tantalum pentoxide (Ta₂O₅), or a composite medium formed by integrating one of these materials with a dielectric material such as silicon nitride or silicon dioxide can be used as well, as long as they support the underlying functionalities. As will be further appreciated by a PHOSITA, all or some of the device components can be physically integrated on the same device platform, or on separate device platforms, or on separate device systems.

Advantageously, SFG offers ‘nature-based,’ scalable, and ultrafast MAC operation, with unlimited size of vector/matrix and extremely low latency, and MAC operation directly on the optical field (rather than optical intensity), thus supporting MAC operation of complex variables. Moreover, LN EOM offers extremely high-speed encoding of both the vector and the matrix, with low power consumption while LN EOM and SFG offer high-precision programming of the vector/matrix and MAC operation. The foregoing combination of features enables a novel matrix-vector multiplication (MVM) modality that promises to transform the state of the art of in-memory computing with unprecedented speed, scalability, parallelism, accuracy, and power consumption.

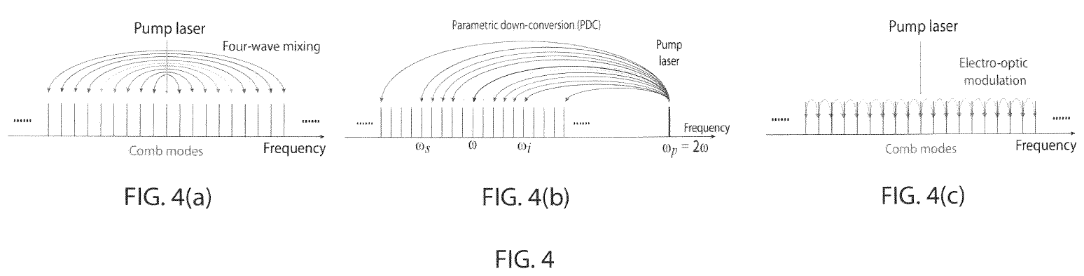

In the description hereinbelow, a LN PIC platform will serve as an example platform. FIG. 4 is a schematic drawing showing well understood optical comb generation mechanisms inside a high-Q microresonator via a) four-wave mixing (FWM), b) parametric down conversion (PDC), and c) electro-optic modulation (EOM). With the strong nonlinear effect, a pump laser launched into the resonator produces a massive number of coherent comb modes at equally spaced frequencies whose phases are locked with each other. The phase locking among the comb lines leads to a common phase across the entire comb spectrum and a well-defined spectral profile that corresponds to chirp-free optical solitons in time domain. Consequently, the phase-locked microcombs exhibit exceptionally low phase noise and low timing jitter. Such an ultralow-noise phase-locked broadband microcomb is particularly advantageous for the embodied application in the instant hyperspectral tensor core. Moreover, in addition to the three mechanisms listed above, the phase-locked optical comb can also be produced by a mode-locked laser.

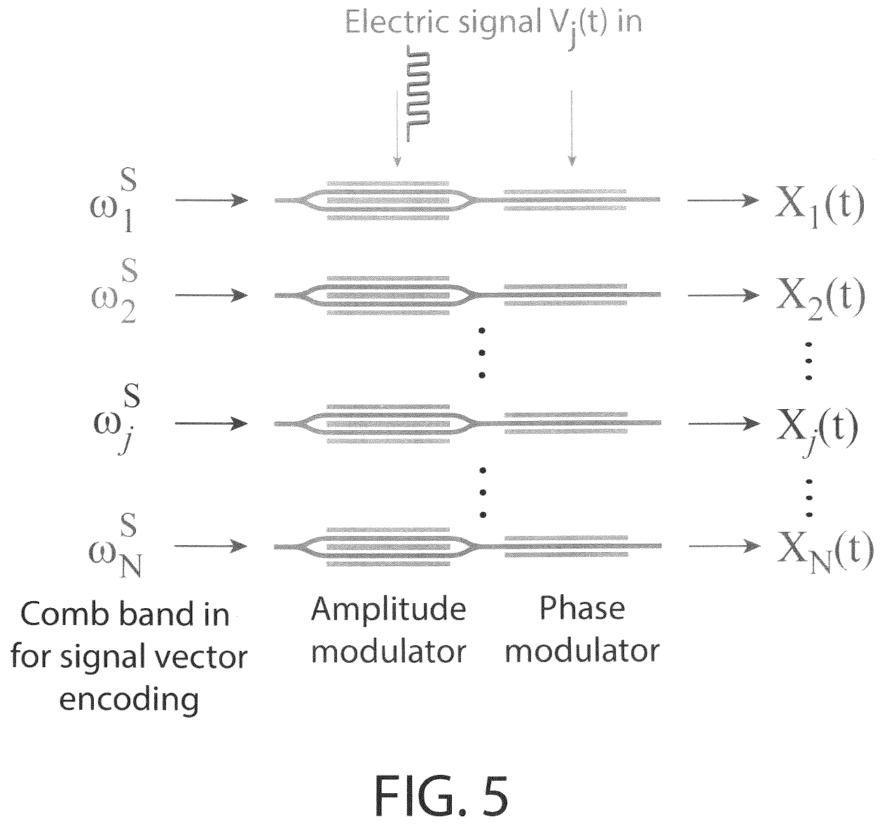

FIG. 5 is a schematic drawing illustrating encoding a computing vector {Xⱼ} onto comb modes via electro-optic modulation (EOM). To encode the computing vector {Xⱼ} (j=1, . . . , N) onto the comb, we select a band of N consecutive comb modes with optical frequency ωⱼ^{s} (j=1, . . . , N). The comb mode field at ωⱼ^{s} is electro-optically modulated in both amplitude and phase to produce the vector element Xⱼ. The same set of amplitude modulators can be used to compensate the deterministic spectral non-uniformity of the input microcomb whenever necessary, by biasing the EOMs with appropriate known voltages.

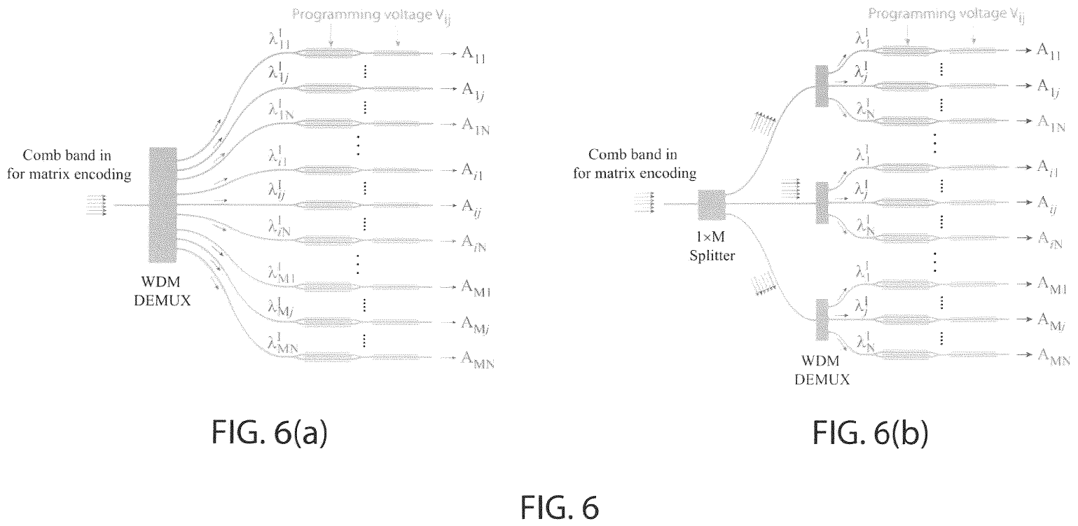

We describe two ways to encode the computing matrix {Aᵢⱼ} onto the comb as illustrated in FIG. 6. In the first approach (FIG. 6(a)), the whole matrix is encoded onto a band of M×N consecutive comb modes at optical frequency of ωᵢⱼ^{l} (i=1, . . . , M; j=1, . . . , N). In the second approach (FIG. 6(b)), we select a band of N consecutive comb modes with optical frequency of (j=1, . . . , N) and split the whole comb band equally into M parts. Each part is used to encode a row of {Aᵢⱼ}. An LN EOM requires only capacitive driving and the energy needed to program an element Aᵢⱼ is CVᵢⱼ²/2 where C is the EOM input capacitance and Vᵢⱼ is the driving voltage. The programming voltages {Vᵢⱼ} will be generated by a peripheral I/O electrical circuit that is used to support the optical tensor core chip.

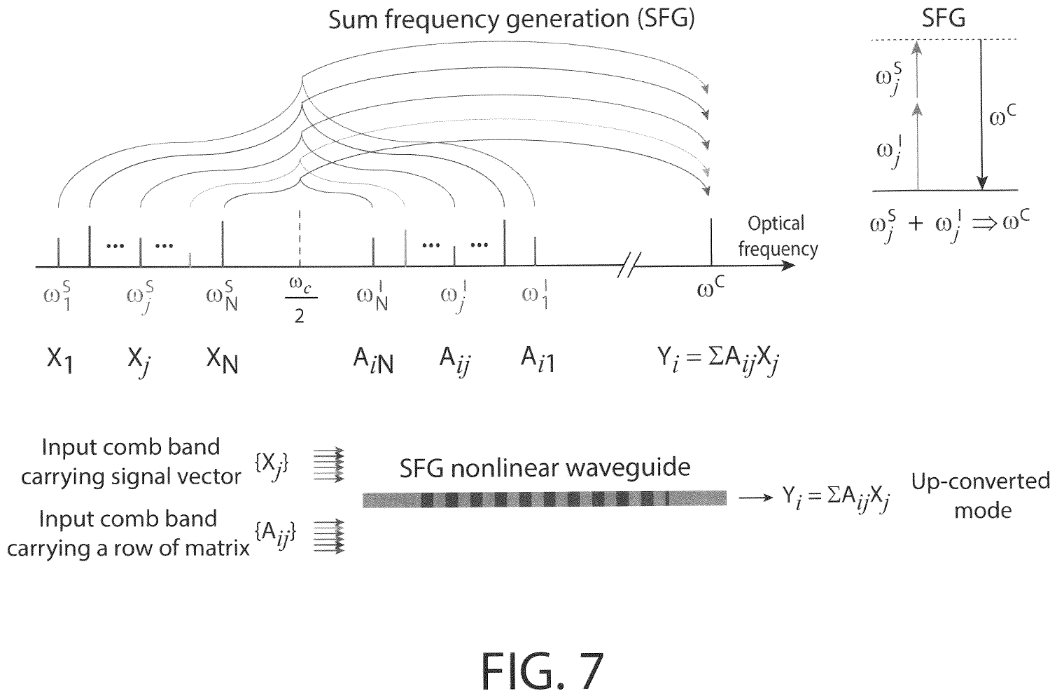

As shown in FIG. 7, the SFG process combines two optical fields of Xⱼ and Aᵢⱼ at frequencies ωⱼ^{s} and ωⱼ^{l}, respectively, and produces an up-converted optical field with an amplitude of ηAᵢⱼXⱼ at frequency ω^{c}=ωⱼ^{s}+ωⱼ^{l} (where η is the slope efficiency). Therefore, SFG performs the MAC operation by its very nature. In particular, SFG between two comb bands {Xⱼ} and {Aᵢⱼ} (j=1, . . . , N) at two equally-spaced frequency sets of {ωⱼ^{s}} and {ωⱼ^{l}} will produce an up-converted field with an amplitude of Yᵢ=ΣⱼηAᵢⱼXⱼ at a single frequency ω^{c}=ωⱼ^{s}+ωⱼ^{l} (j=1, . . . , N), which naturally perform a dot product between two vectors. Note advantageously that SFG performs MAC operation on the optical field directly (rather than optical power), thus capable of MAC operation of complex variables.

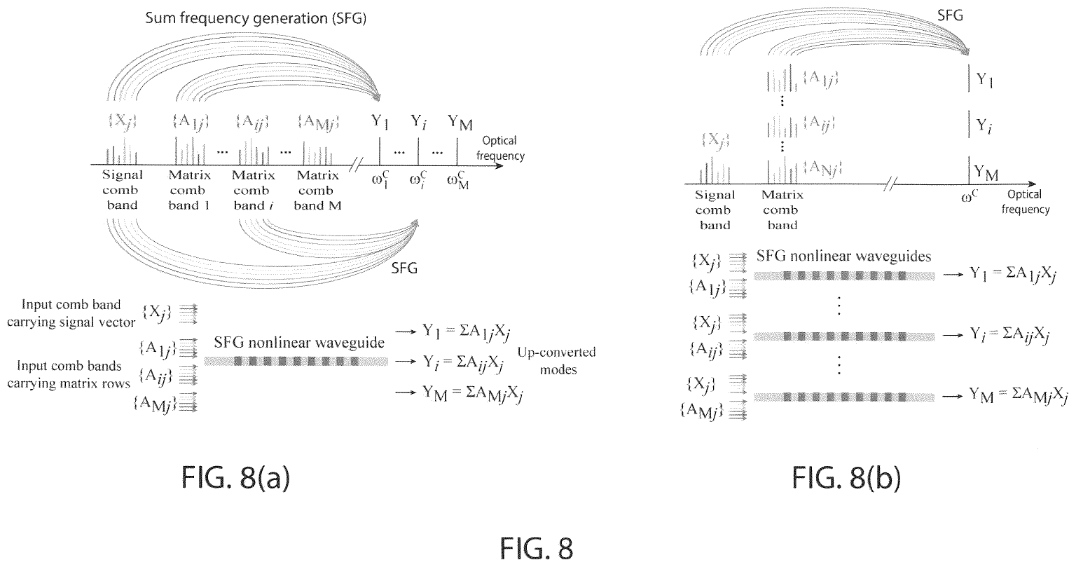

The unique SFG-based MAC operation principle thus enables direct hyperspectral operation of the matrix-vector product as shown in FIG. 8. The matrix-vector product can be realized in two ways, depending on how the matrix is encoded on the comb. If the matrix is encoded on a whole set of comb modes (FIG. 6(a)), SFG between the vector comb and the matrix comb will produce a set of up-converted fields at equally spaced frequencies ωᵢ^{c} (i=1, . . . , M), each with an amplitude of Yᵢ=ΣⱼηAᵢⱼXⱼ. This approach is shown in FIG. 8(a). However, if the matrix rows are encoded on a same frequency set of comb modes according to FIG. 6(b), the set of up-converted fields will be produced at the same frequency ω^{c}=ωⱼ^{s}+ωⱼ^{l}, while each with an amplitude of Yᵢ=ΣⱼηAᵢⱼXⱼ. This second approach is shown in FIG. 8(b). In this case, SFG for different matrix rows will be realized in different nonlinear waveguides. The approach in FIG. 6(b) has an advantage that it utilizes only a limited number of comb modes for matrix programming, while the approach in FIG. 6(a) has an advantage that SFG can be realized in a single nonlinear waveguide.

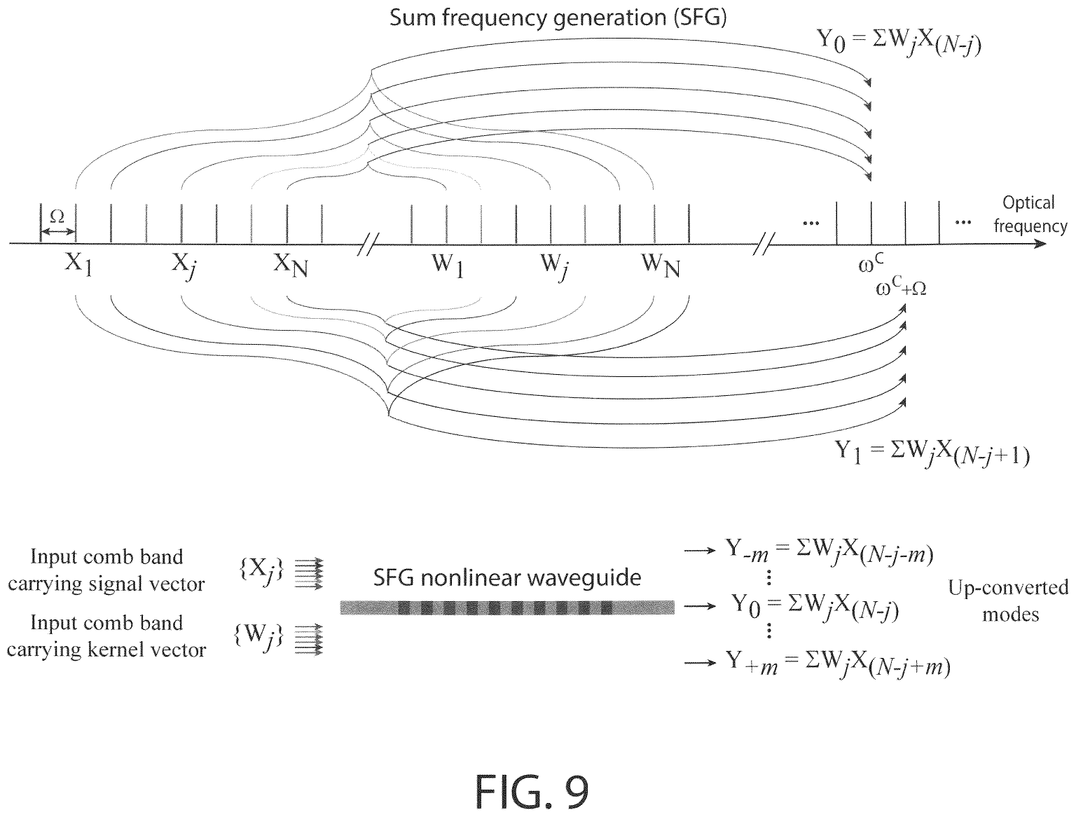

In addition to these two hyperspectral matrix-vector product operations, the SFG-based MAC operation also uniquely supports a third hyperspectral operation—convolution between two vectors. FIG. 9 illustrates the operation principle. For two vectors {Xⱼ} and {Wⱼ} (j=1, . . . , N) encoded on two equally-spaced frequency sets of comb modes, SFG between them can not only produce an up-converted field at frequency ω^{c} with an amplitude of Y₀=ΣⱼηWⱼX_{(N-j)} (similar to FIG. 7), but also produce up-converted fields at equally spaced frequencies of ω^{c}+mΩ (m=−N, . . . , +N) with amplitudes of Yₘ=ΣⱼηWⱼX_{(N-j+m)}, respectively, where Ω is the mode spacing of the combs (see FIG. 9). Clearly, {Yₘ} is the convolution between {Xⱼ} and {Wⱼ}. Such a ‘nature-based’ convolution operation will have vastly broad applications. Note that the whole convolution process is realized with a single SFG nonlinear waveguide as shown in FIG. 9. In practice, the up-converted comb modes at ω^{c}+mΩ carrying the vector {Yₘ}, output from the nonlinear waveguide, can be separated into individual comb modes with a wavelength-division demultiplexer (WDM DEMUX) for optical detection of individual vector elements. Note also that the hyperspectral convolution operation shown in FIG. 9 is distinctive to the hyperspectral matrix-vector product shown in FIG. 8(a) since the optical fields after the convolution operation appear at a frequency set of ω^{c}+mΩ that are near ω^{c} (FIG. 9), while the optical fields after matrix-vector product operation appear at frequencies far separated from ω^{c} with frequency difference equal to those between the matrix-encoded comb bands (FIG. 8(a)).

In general, SFG is a very powerful MAC operation approach. Together with difference frequency generation (DFG), more matrix operation can be realized, such as cross product and outer product. Furthermore, in addition to the SFG based upon the quadratic optical nonlinearity (χ⁽²⁾ nonlinearity) that is utilized in FIGS. 7-9, SFG and FWM based upon the third-order optical nonlinearity (χ⁽³⁾ nonlinearity) can also be used for MAC operations and more complex MAC operations.

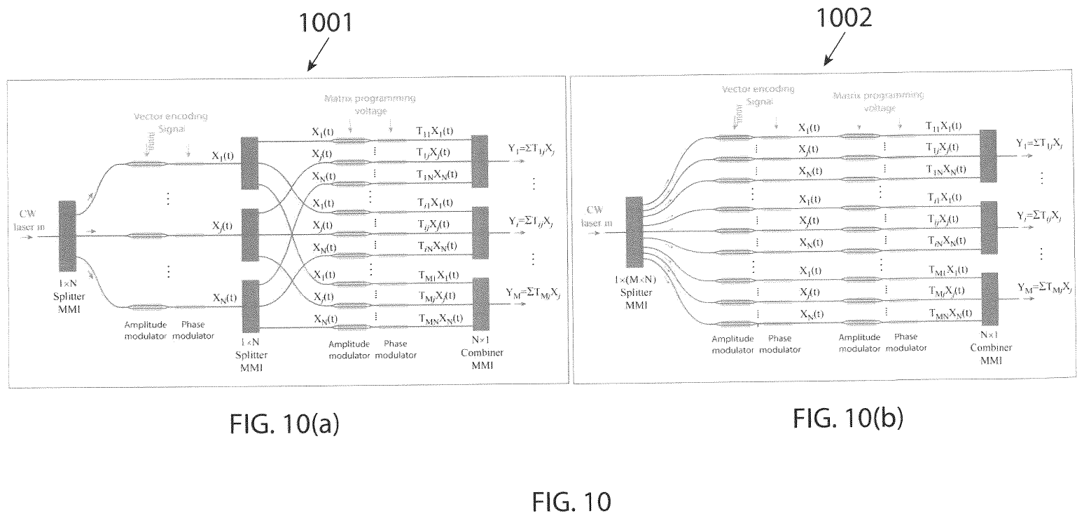

The hyperspectral optical tensor core device can also be realized with parallel multimode interferometer (MMI) networks 1001, 1002 as shown in FIGS. 10(a) and 10(b). The parallel approach splits the M×N matrix operation into the Minner products of 1×N and N×1 vectors, i.e., the matrix row vector and input column vector. As shown at 1001 in FIG. 10(a), the input CW laser is equally split into N parts with a 1×N splitter MMI, each of which is electro-optically modulated in amplitude and phase to encode the input vector element Xⱼ(t). Each channel is then again split into M parts with a 1×N splitter MMI, each of which is electro-optically modulated to encode the matrix element Tᵢⱼ to obtain TᵢⱼXⱼ(t). After that, all of TᵢⱼXⱼ(t) (j=1, 2, . . . , N) is grouped together and launched into a N×1 combiner MMI for the summing function to obtain the output vector element Yᵢ(t)=ΣⱼTᵢⱼXⱼ(t). The MAC operation can be realized with a similar configuration 1002 shown in FIG. 10(b), where the input CW laser is split into M×N parts each of which is electro-optically modulated sequentially to encode Xⱼ(t) and Tᵢⱼ. The advantage of FIG. 10(a) is that it uses just the right number of EOMs but it requires appropriate design of the waveguide crossing to eliminate potential crosstalk. This crossing challenge is eliminated in FIG. 10(b), while it will require extra EOMs for encoding the input vector element Xⱼ(t). For hyperspectral operation, the input CW laser is replaced with a microcomb.

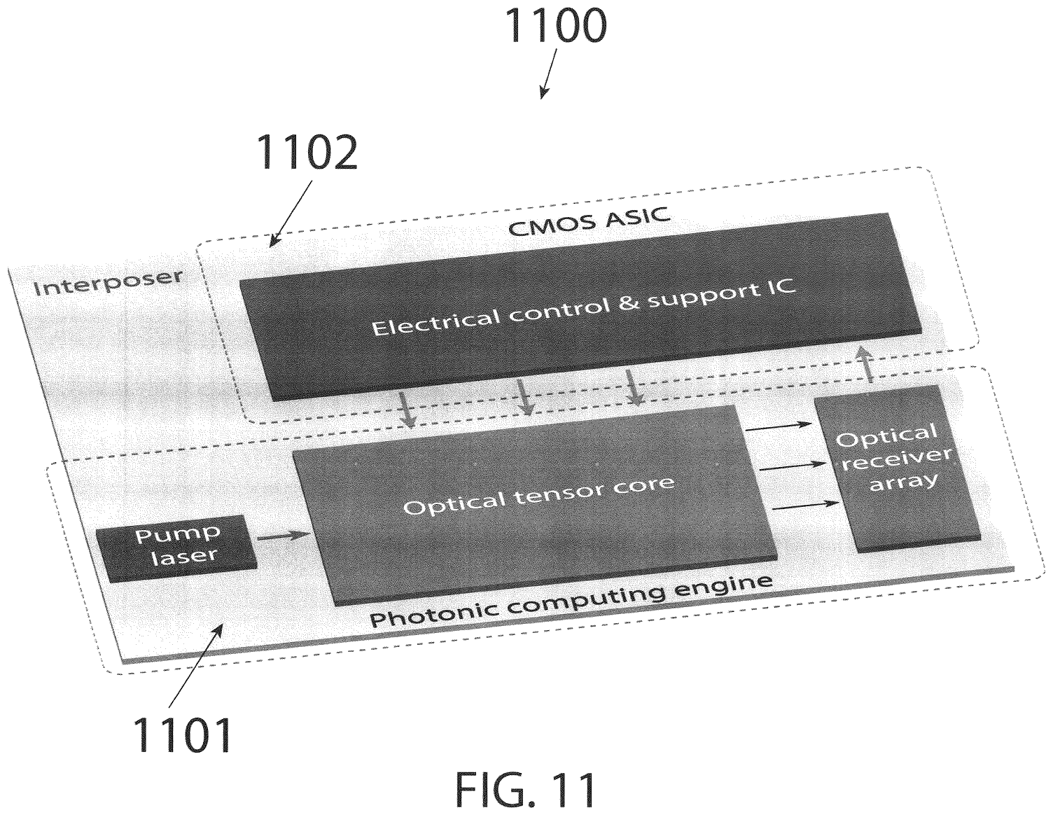

FIG. 11 schematically illustrates an integrated optical tensor core system 1100. The system includes two major parts: 1) the photonic computing engine 1101 that includes the optical tensor core, a pump laser to produce the microcomb, and an optical receiver array to detect the computed optical waves output from the optical tensor core; 2) the electrical I/O circuits 1102 to provide programming voltages to the optical tensor core and to process the received signals from the optical receiver array, and to characterize the computing performance.

While various disclosed embodiments have been described above, it should be understood that they have been presented by way of example only and not as a limitation. Numerous changes to the disclosed embodiments can be made in accordance with the specification herein without departing from the spirit or scope of this specification. Thus the breadth and scope of this specification should not be limited by any of the above-described embodiments; rather, the scope of this specification should be defined in accordance with the appended claims and their equivalents.

I claim:

1. An optical tensor core, comprising:
a device platform;
a broadband, phase-locked, optical frequency comb generator;
a plurality of electro-optic (EO) modulators adapted to EO modulate a respective plurality of comb mode fields of a broadband, phase-locked, optical comb produced by the comb generator, wherein a vector, {Xⱼ}, and a matrix, {Aᵢⱼ} are encoded onto the optical comb mode fields; and
a non-linear waveguide operationally integrated with an output port of the E-O modulators, wherein a sum frequency generation (SFG) operation occurs directly on the optical comb mode fields so as to realize a multiply-accumulate (MAC) operation between the vector, {Xⱼ}, and the matrix, {Aᵢⱼ},
further wherein at least one of the frequency comb generator, the plurality of electro-optic (EO) modulators, and the non-linear waveguide are disposed on the non-linear photonics platform.

2. The optical tensor core of claim 1, wherein the broadband, phase-locked, optical frequency comb generator is a high-Q microresonator.

3. The optical tensor core of claim 1, further comprising a wavelength division demultiplexer (WDM DEMUX) and a wavelength division multiplexer (WDM MUX) operationally disposed intermediate the high-Q microresonator and the non-linear waveguide.

4. The optical tensor core of claim 3, wherein the frequency comb generator, the EO modulator array, the nonlinear optical waveguide, and the WDM MUX and WDM DEMUX are disposed on separate, operationally integrated platforms.

5. The optical tensor core of claim 1, wherein the device platform is one of a lithium niobate (LiNBO₃), lithium tantalate (LiTaO₃), potassium niobate (KNbO₃), III-V semiconductors (AlN, GaN, GaP, GaAs, AlGaAs, InP), barium titanate (BaTiO₃), silicon nitride, silica, tantalum pentoxide (Ta₂O₅), or a composite medium formed by integrating one of these materials with a dielectric material such as silicon nitride or silicon dioxide.

6. An integrated optical tensor core system, comprising:
a photonic computing engine that includes:
an optical tensor core,
a pump laser suitably adapted to produce a broadband, phase-locked, optical frequency comb, and
an optical receiver array suitably adapted to detect a computed optical output from the optical tensor core; and
an electrical I/O circuit suitably adapted to provide programming voltages to the optical tensor core and to process the received signals from the optical receiver array, and to characterize the computing performance.

7. The integrated optical tensor core system of claim 6, wherein the optical tensor core further comprises:
a device platform;
a broadband, phase-locked, optical frequency comb generator;
a plurality of electro-optic (EO) modulators adapted to EO modulate a respective plurality of comb mode fields of a broadband, phase-locked, optical comb produced by the comb generator, wherein a vector, {Xⱼ}, and a matrix, {Aᵢⱼ} are encoded onto the optical comb mode fields; and
a non-linear waveguide operationally integrated with an output port of the E-O modulators, wherein a sum frequency generation (SFG) operation occurs directly on the optical comb mode fields so as to realize a multiply-accumulate (MAC) operation between the vector, {Xⱼ}, and the matrix, {Aᵢⱼ}.

8. A method for performing a multiply-accumulate (MAC) operation between a vector element, {Xⱼ}, and a matrix element, {Aᵢⱼ} using an optical tensor core, comprising:
generating a broadband, phase-locked optical comb having a spectral bandwidth;
encoding a computing vector, {Xⱼ}, and a matrix, {Aᵢⱼ} on different spectral bands of the optical comb mode field; and
performing a sum frequency generation (SFG) operation directly on the vector- and matrix-encoded optical comb mode fields so as to realize a multiply-accumulate (MAC) operation between the vector, {Xⱼ}, and the matrix, {Aᵢⱼ}.

9. The MAC method of claim 8, wherein the step of generating the broadband, phase-locked optical comb mode field further comprises one of four-wave mixing, parametric down-conversion, and electro-optic modulation.

10. The MAC method of claim 8, wherein the step of encoding a computing vector with a length of N, {Xⱼ} (j=1, . . . , N), on the spectral bands of the optical comb mode field further comprises selecting a band of N comb modes at an equally spaced frequency set of {ωⱼ^{s}} (j=1, . . . , N) and electro-optically modulating the amplitude and phase of the selected band of comb modes to generate the computing vector, {Xᵢⱼ}.

11. The MAC method of claim 8, wherein the step of encoding a matrix {Aᵢⱼ} with a dimension of M×N on the spectral bands of the optical comb mode field further comprises one of:
i)
(a) encoding a row of the matrix {Aᵢⱼ} (j=1, . . . , N) with a length of N onto a band of N comb modes at an equally spaced optical frequency set of {ωⱼ^{l}} (j=1, . . . , N),
(b) encoding different rows of the matrix {Aᵢⱼ} onto different spectral bands of the comb; and
ii)
(a) selecting a band of N comb modes at an equally spaced frequency set of {ωⱼ^{l}} (j=1, . . . , N),
(b) splitting the whole comb band equally into M parts; and
(c) using each part to encode a row of {Aᵢⱼ}.

12. The MAC method of claim 8, wherein the step of encoding vector and matrix further comprises biasing the EO modulators with appropriate voltages so as to compensate for a spectral non-uniformity of the input comb.

13. The MAC method of claim 8, wherein the step of encoding vector/matrix and the step of MAC operation further comprise encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency ω^{c}=ωⱼ^{s}+ωⱼ^{l} (j=1, . . . , N), with an amplitude of Yᵢ=ΣⱼηAᵢⱼXⱼ (where η is a slope efficiency of the SFG process),
wherein the MAC operation realizes a dot product between the two vectors.

14. The MAC method of claim 8, wherein, in conjunction with a matrix encoding method comprising
(a) encoding a row of the matrix {Aᵢⱼ} (j=1, . . . , N) with a length of N onto a band of N comb modes at an equally spaced optical frequency set of {ωⱼ^{l}} (j=1, . . . , N), and
(b) encoding different rows of the matrix {Aᵢⱼ} onto different spectral bands of the comb;
and a dot product operation comprising encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency ω^{c}=ωⱼ^{s}+ωⱼ^{l} (j=1, . . . , N), with an amplitude of Yᵢ=ΣⱼηAᵢⱼXⱼ (where η is a slope efficiency of the SFG process), the step of MAC operation further comprises SFG between the comb band carrying the vector {Xⱼ} and different comb bands carrying different rows of the matrix {Aᵢⱼ} to produce a set of converted optical fields at equally spaced frequencies ωᵢ^{c} (i=1, . . . , M), each with an amplitude of Yᵢ=ΣⱼηAᵢⱼXⱼ (i=1, . . . , M),
wherein the MAC operation realizes a matrix-vector multiplication.

15. The MAC method of claim 8, wherein, in conjunction with a matrix encoding method comprising
(a) selecting a band of N comb modes at an equally spaced frequency set of {ωⱼ^{l}} (j=1, . . . , N),
(b) splitting the whole comb band equally into M parts; and
(c) using each part to encode a row of {Aᵢⱼ}
and a dot product operation comprising encoding the vector {Xⱼ} with appropriate order on a comb band at an equally spaced frequency set {ωⱼ^{s}}, encoding a row of the matrix {Aᵢⱼ} with appropriate order on another comb band at an equally spaced frequency set {ωⱼ^{l}}, and SFG between the two comb bands to produce an optical field at a single frequency ω^{c}=ωⱼ^{s}+ωⱼ^{l} (j=1, . . . , N), with an amplitude of Yᵢ=ΣⱼηAᵢⱼXⱼ (where η is a slope efficiency of the SFG process), the step of MAC operation further comprises SFG in M separate nonlinear waveguides to realize dot product operations between the vector {Xⱼ} and individual rows of the matrix {Aᵢⱼ}, each in one nonlinear waveguide, to produce up-converted optical fields at a same frequency ω^{c}=ωⱼ^{s}+ωⱼ^{l} but with different amplitudes of Yᵢ=ΣⱼηAᵢⱼXⱼ (i=1, . . . , M), output from the set of nonlinear waveguides,
wherein the MAC operation realizes a matrix-vector multiplication.

16. The MAC method of claim 8, wherein the step of vector/matrix encoding and the step of MAC operation further comprises encoding the vector {Xⱼ} with appropriate order on a comb band at an equally spaced frequency set {ωⱼ^{s}} and encoding another vector {Wⱼ} with appropriate order on another comb band at an equally spaced frequency set {ωⱼ^{l}}, and performing SFG between the two comb bands to produce optical fields at equally spaced frequencies of ω^{c}+mΩ (m=−N, . . . , +N) with amplitudes of amplitudes of Yₘ=ΣⱼηWⱼX_{(N-j+m)}, respectively, where Ω is the mode spacing of the combs, wherein the MAC operation realizes a convolution between {Xⱼ} and {Wⱼ}.
